(19) United States
(12) Patent Application Publication
(10) Pub. No.: US 2024/0194384 A1
(43) Pub. Date: Jun. 13, 2024

(54) RARE EARTH PORTABLE MAGNET CLEANING APPARATUS HAVING A QUICK CLEAN SLEEVE

(71) Applicant: Bluestreak Equipment Inc., Delhi (CA)

(72) Inventors: Brian WEBER, Delhi (CA); Matthew NORMAN, Delhi (CA)

(21) Appl. No.: 18/536,134

(22) Filed: Dec. 11, 2023

Related U.S. Application Data
(63) Continuation of application No. 29/875,176, filed on Apr. 29, 2023.
(60) Provisional application No. 63/431,692, filed on Dec. 10, 2022.

(51) Int. Cl. H01F 7/02; A47L 13/41

(52) U.S. Cl. CPC H01F 7/02; A47L 13/41

(57) ABSTRACT

A rare earth portable magnetic cleaning apparatus configured to collect magnetic debris. The portable magnetic cleaning apparatus comprises a quick clean-off sleeve, a handle body, an ergonomic and extendable handle and an internal rare earth housing. The quick clean-off sleeve is a four-sided plastic sleeve held on and released with push button mechanism. The sleeve slips on an off easily to easily clean off debris. The ergonomic and extendable handle slides on over the main magnet tube housing to reduce operator strain and fatigue and accommodate operators of different heights. The internal rare earth housing consists of an internal plastic device to allow rare earth magnets to be charged as an assembly and then safely handled by the user. The housing holds the rare earth magnets in a proximity to each other that would otherwise push apart/rotate/attract them to each other after magnetization.

### CROSS REFERENCE TO RELATED APPLICATIONS

This application claims priority to and the benefit of U.S. Provisional Application Ser. No. 63/431,692, entitled “RARE EARTH PORTABLE MAGNET CLEANING APPARATUS HAVING A QUICK CLEAN SLEEVE”, filed on Dec. 10, 2022, and U.S. Design application Ser. No. 29/875,176, entitled “RARE EARTH PORTABLE MAGNET CLEANING APPARATUS HAVING A QUICK CLEAN SLEEVE”, filed on Apr. 29, 2023, the disclosures of which are incorporated herein by reference in its entirety.

### BACKGROUND

The field of the disclosure relates to magnetic cleaning apparatuses, in particular to a portable magnetic sweeper apparatus.

A portable magnetic sweeper apparatus (such as the Powerstik) can be used to collect metal debris on the sweeper handle body. However, there may be some deficiencies with this design. For example, when users want to remove the metal debris from the tool, it can be hazardous for human hands to remove the sharp debris, requiring the need for gloves or other protective gear and slowing down the process.

Furthermore, using the portable magnetic sweeper apparatus' (e.g., Powerstik) aluminum handle body on abrasive surfaces, causes the aluminum to wear out allowing the magnetic core to separate from it, leaving the product no longer usable.

The magnet assembly of the portable magnetic sweeper apparatus may not be strong enough to meet certain users' requirements. Furthermore, the hand grip of certain portable magnetic sweeper apparatuses may not be comfortable for long periods of use, and the product may be too short for some operators.

There is a desire to create a portable magnetic sweeper apparatus that addresses some of these deficiencies.

### SUMMARY

A rare earth portable magnetic cleaning apparatus configured to collect magnetic debris. The portable magnetic cleaning apparatus comprises a quick clean-off sleeve, a handle body, an ergonomic and extendable handle and an internal plastic housing containing rare earth magnets. The quick clean-off sleeve is a four-sided plastic sleeve held on and released with push button mechanism. The sleeve slips on easily and requires the depressing of a push button mechanism for easy removal to clean off metal debris. The ergonomic and extendable handle slides on over the main magnet tube housing to reduce operator strain and fatigue and accommodate operators of different heights. The internal housing consists of an internal plastic device to allow rare earth magnets to be charged as an assembly and then safely handled by the user. The housing holds the rare earth magnets in a proximity to each other that would otherwise push apart/rotate/attract them to each other after magnetization.

### BRIEF DESCRIPTION OF THE DRAWINGS

FIG. 1 is a line diagram of an exemplary portable magnetic sweeper apparatus.

FIG. 2 is a line diagram of a further embodiment of a portable magnetic sweeper apparatus.

FIG. 3 is a line diagram of a perspective view of a magnetic sweeper apparatus.

FIG. 4A is a line diagram of a perspective view of the quick clean-off sleeve.

FIG. 4B is a line diagram of a top plan view of a quick clean-off sleeve.

FIG. 5A is a line diagram of a perspective view of a magnet assembly.

FIG. 5B is a line diagram of a top plan view of a magnet assembly.

FIG. 5C is a line diagram of a front plan view of a magnet assembly.

FIG. 6 is a line diagram of a portable sweeper apparatus illustrating reaction forces.

FIG. 7A is a line diagram of a front plan view of a grip rest of a portable sweeper apparatus.

FIG. 7B is a line diagram of a left side view of a grip rest of a portable sweeper apparatus.

### DETAILED DESCRIPTION

According to the disclosure, an improved portable magnetic sweeper apparatus is disclosed. The improved portable magnetic sweeper apparatus consists of three unique features:

Quick Clean-Off Sleeve: a four-sided plastic sleeve held on and released with a push button mechanism. The sleeve has built in wear bars that extend the life of the plastic sleeve that in turn also extend the life of the aluminum magnetic sweeper housing it covers, by providing a secondary surface to wear out. The sleeve slips on and off easily to easily clean off debris.

Internal rare earth containment housing: internal plastic device to allow rare earth magnets to be charged as an assembly and then safely handled by manufacturing employees. The housing will be placed inside the body (housing) of the Powerstik Pro and remain there to maintain the position of the magnet and to prevent the magnets from coming out. The housing holds the rare earth magnets in a proximity to each other that would otherwise push apart/rotate/attract them to each other after magnetization.

Ergonomic and extendable handle: a plastic handle part which slides on over the handle body to reduce operator strain and fatigue and to accommodate operators of different heights, and which incorporates a push button mechanism to move the handle position.

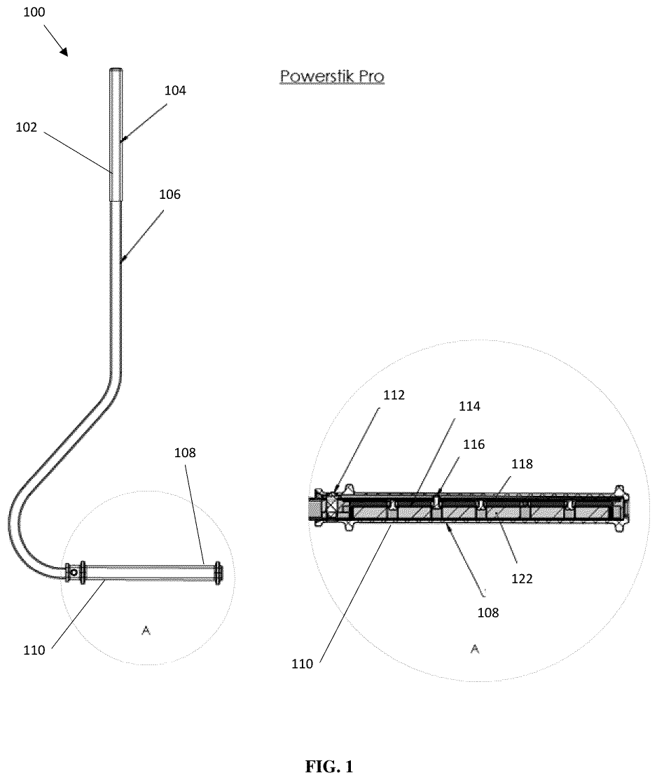

FIG. 1 is a line diagram of an exemplary portable magnetic sweeper apparatus. According to FIG. 1, to minimize the hazard posed to the operator, a high strength portable magnetic sweeper apparatus 100 was developed (referred to as “Powerstik Pro”). The portable magnetic sweeper apparatus 100 has an ergonomic handle 102 with a vinyl grip 104, an aluminum handle body 106, a 4-sided plastic sleeve 108, known as the Quick Clean-Off Sleeve (QCS) that is a removable collection device, and a magnet assembly 110.

According to FIG. 1, section A is a close-up view of the magnet assembly 110. The magnet assembly 110 further comprises a spring pin 112, a steel backplate 114, assembly rivet 116 and a magnet tray 118. Contained within the magnet assembly 110 is a collection of rare earth magnets 122.

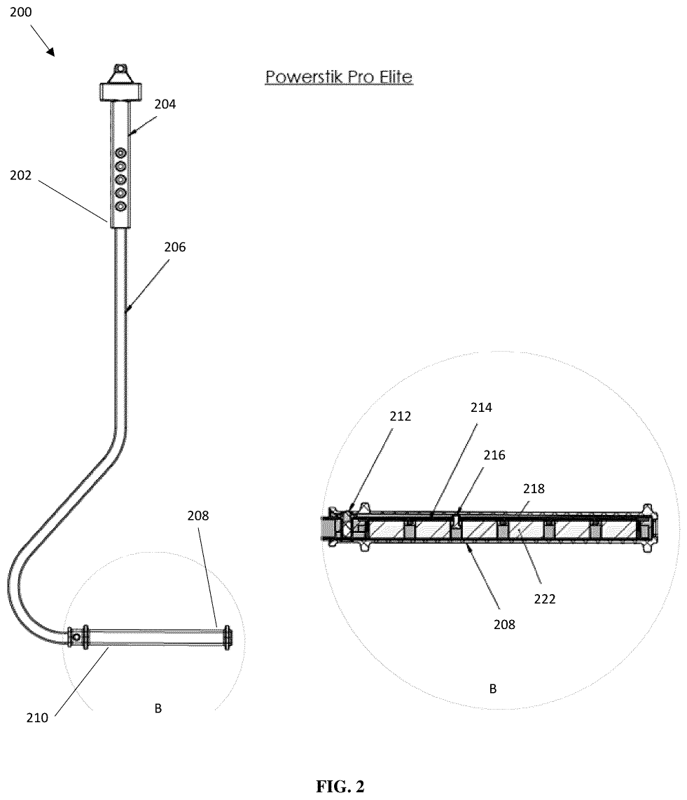

FIG. 2 is a line diagram of a further embodiment of a portable magnetic sweeper apparatus. According to FIG. 2, a further portable magnetic sweeper apparatus 200 (referred to as Powerstik Pro Elite) consists of an ergonomic handle 202, an ergonomic grip rest 204, an aluminum handle body 206, a quick clean-off sleeve 208, and a larger/stronger magnet assembly 208 then the Powerstik Pro.

According to FIG. 2, section B is a close-up view of the magnet assembly 210. The magnet assembly 210 further comprises a spring pin 212, a steel backplate 214, assembly rivet 216 and a magnet tray 218. Contained within the magnet assembly 210 is a collection of rare earth magnets 222.

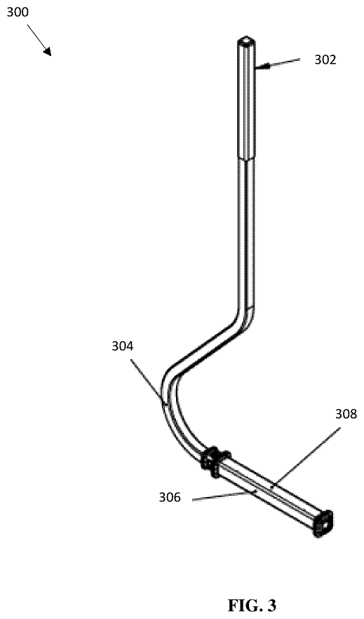

FIG. 3 is a line diagram of a perspective view of a magnetic sweeper apparatus. According to FIG. 3A, magnetic sweeper apparatus 300 consists of hand grip 302, a crook-shaped design 304, a magnet assembly 306 and clean-off sleeve 308.

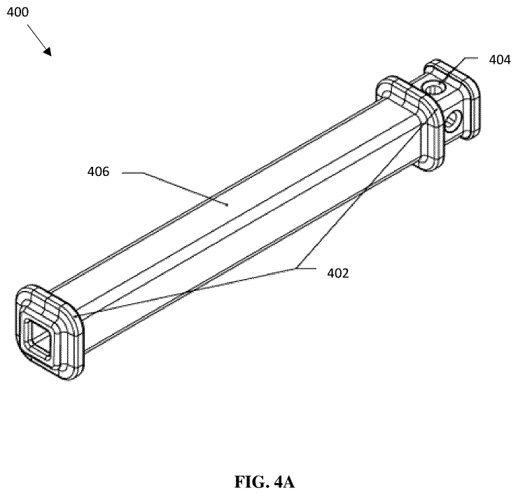

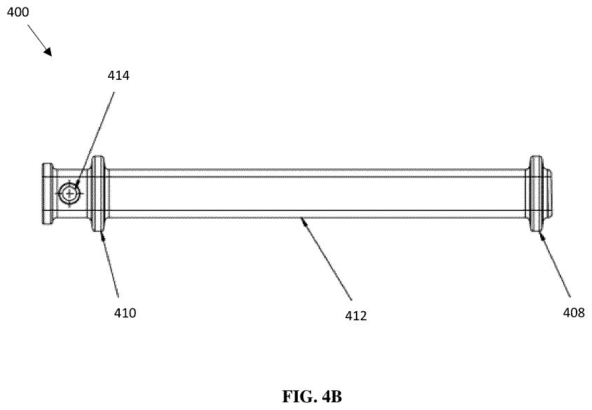

FIG. 4A is a line diagram of a perspective view of the quick clean-off sleeve. According to FIG. 4A, quick clean-off sleeve 400 comprises a 4-sided wear bar 402, a sleeve alignment module 404 with retaining holes and a 4-sided debris collection area 406.

FIG. 4B is a line diagram of a top plan view of the quick clean-off sleeve. According to FIG. 4B, the quick clean-off sleeve (QCS) 400 comprises a wear bar 408, an extraction handle 410, a debris collection area 412 and a locking pin cavity 414. The quick clean-off sleeve (QCS) 400 slides on over the main sweeper magnet housing. The dimensions of sleeve 400 are 14.15″ length, 2.08″ width and 2.08″ height.

To safely release debris from the Powerstik the operator can simply press the spring-loaded button and slide the plastic sleeve off the Powerstik body. In doing so, it will remove debris from the magnetic field allowing safe disposal of the metal debris.

According to FIGS. 4A and 4B, the sleeve 400 is installed over-top of the aluminum handle body that contains the magnets. When attaching the quick clean-off sleeve, a lead in depresses the spring loaded locking button and holds the quick clean-off sleeve firmly in place. Once aligned with a locking cavity on the sleeve no further movement is allowed. When removal is desired, the operator must depress this spring pin manually, allowing the sleeve to move with respect to the Powerstik body.

According to the disclosure, the quick clean-off sleeve (QCS) also addresses the second main problem of housing wear on abrasive surfaces. The QCS will act as a sacrificial barrier between the aluminum handle body and any abrasive surface the tool travels along. Integrated into the QCS profile are wear bars on each end. These bars' primary function is to separate the collection surface from the surface of travel. A secondary function of these bars is to assist the removing of debris from the magnetic field. To extend the life of the QCS an identical profile is used on all 4 sides of the sleeve. This allows the operator to rotate the QCS when one side is reaching its end of life. When all 4 sides have been depleted a replacement device may be ordered. The QCS has a secondary effect of accelerating collection cycles, as removing the sleeve is quicker than removing debris by hand.

The Powerstik Pro and Powerstik Pro Elite make use of rare earth magnets to solve the third problem of not enough magnet power. It was determined that a series of linear discrete blocks would be the best compromise between magnetic field, mass and cost. In order to use the more powerful rare earth blocks a custom tray insert has been developed to both permanently position the magnets in the final product and reduce danger with product assembly.

A steel strip (with or without fasteners securing it to the plastic magnet tray insert) running the length of the tray will use the generated magnetic field during and after the magnetizing process to fix the rare earth magnet blocks in place. Both of the ends of the steel strip are bent to 90 degrees to act as an additional safety measure to ensure the magnet blocks will not dislodge from the handle body if the plastic tray becomes damaged or broken over time. The steel strip is also permanently fastened to the aluminum handle body with a single assembly rivet after insertion to ensure the high strength magnet assembly is not removed. Without the plastic magnet tray insert the rare earth magnets, once magnetized, would want to change position relative to each other. Assembling the permanent rare earth magnets presents crushing and pinch hazards from the strong rare earth magnet blocks thus it is highly desirable from a manufacturing standpoint to assemble the magnets uncharged in the tray insert and then magnetize the magnets after they are in the tray insert. The tray insert invention allows post assembly magnetizing to take place, this is the always the most desirable method of any magnet assembly manufacturing process. During the assembly of un-magnetized magnets, the magnets can easily and safely be placed inside the magnet tray insert invention, as there are no magnetic forces present.

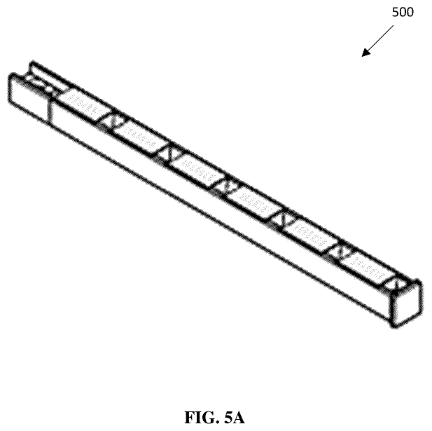

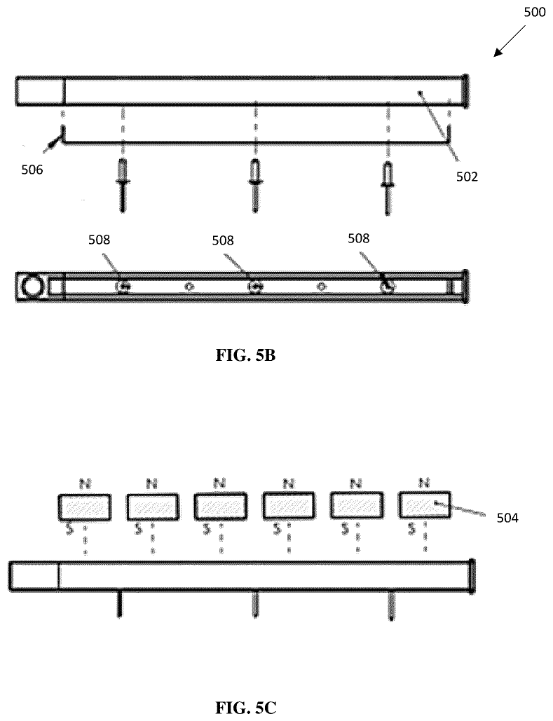

FIGS. 5A to 5C are line diagram illustrating components of the magnet assembly. FIG. 5A is a line diagram of a perspective view of a magnet assembly. FIG. 5B is a line diagram of a top plan view of a magnet assembly. FIG. 5C is a line diagram of a front plan view of a magnet assembly.

According to FIGS. 5A to 5C, magnet assembly 500 consists of a magnet tray 502, a plurality of N42 magnet blocks 504 (can be up to 6 magnets), an 18-gauge steel backing plate 506 and a plurality of blind rivets 508.

Assembly of the portable magnetic sweeper apparatus consists of the following steps:
Place back plate in plastic magnet tray
Lock back plate in place with rivets (Powerstik Pro only)
Place magnet blocks in magnet tray
Magnetize assembly
Insert assembly into magnetic sweeper aluminum handle body
Install rivet thru aluminum handle body into back plate

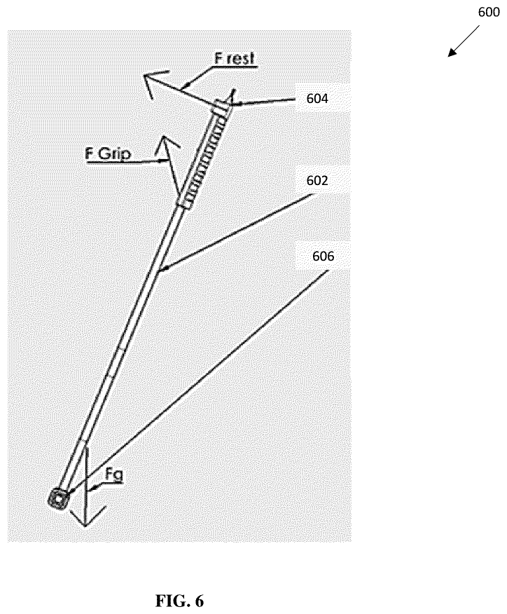

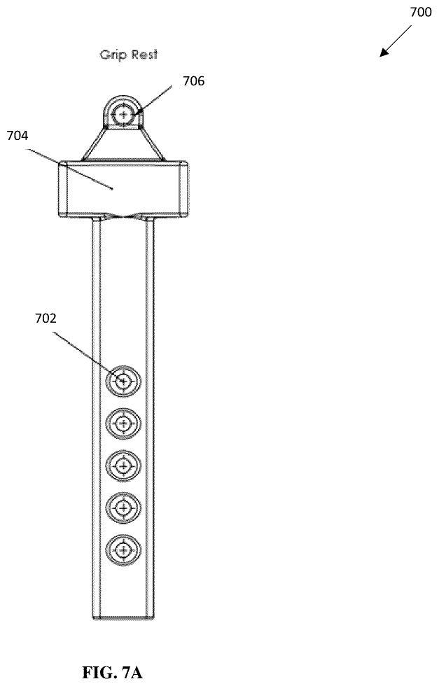

FIG. 6 is a line diagram of a portable sweeper apparatus illustrating reaction forces. Due to the weight of the larger, rare-earth magnets in the Powerstik Pro Elite, and the products weight being primarily at the bottom of the magnetic sweeper a hand grip with arm rest with grip has been created.

According to FIG. 6, a portable magnetic sweeper apparatus consists of an aluminum handle body 602, a grip rest 604 and a quick clean-off sleeve 606. This grip rest will allow the operator to support the weight using their hand and upper forearm, while providing a secure cupped arm placement to counter the induced moment in the system.

According to FIG. 6, difference force diagram directions are also shown. To accommodate users with varying heights the grip rest allows operators to adjust the placement relative to the handle body by means of spring-loaded button.

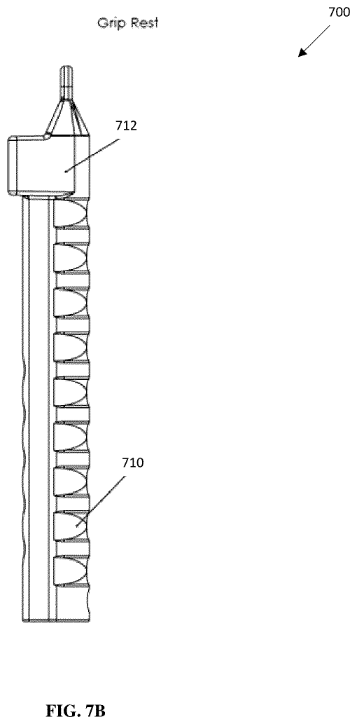

FIG. 7A is a line diagram of a front plan view of a hand grip of a portable sweeper apparatus. According to FIG. 7A, the portable magnetic sweeper apparatus grip rest 700 is shown to have a plurality of positioning holes 702, an armrest 704 and a hanger 706.

FIG. 7B is a line diagram of a left side view of a grip rest of a portable sweeper apparatus. According to FIG. 7B, the portable magnetic sweeper apparatus grip rest 700 of the handle is shown to have a plurality of finger positioners 710 and a counter weight mass 712. According to the disclosure, the grip rest handle can be made from one or two pieces. The grip rest handle can be made of plastic or other composite materials.

According to the disclosure, a portable magnetic sweeper apparatus is disclosed as:
Having a Quick Clean-Off Sleeve (QCS) which allows a user to safely remove metal debris, this solution potentially reducing the collection area (since the debris comes off the end in one pile) while also providing protection from wear on the product's main aluminum handle body;
Using a rare earth magnets solution; and
Having a unique grip rest for operating the product to reduce operator fatigue and accommodate users of different heights.

According to the disclosure, the magnets can be Neodymium 42 rare earth magnets. The magnet block sizes can range from 1.5″ length, 0.72″ width and 0.5″ height for the Powerstik Pro, to 1.5″ length, 0.72″ width and 0.75″ height for the Powerstik Pro Elite.

According to the disclosure, the following table illustrates the relationship between sweeping height and magnet strength (in Gauss). Note, 0″ indicates the surface of the quick clean sleeve.

| | 0″ | 0.25″ | 0.5″ | 0.75″ | 1″ |
|---|---|---|---|---|---|
| Powerstik Pro Distance | | | | | |
| Peak Gauss (G) | 2264 | 1015 | 535 | 329 | 237 |
| Powerstik Pro Elite | | | | | |
| Peak Gauss (G) | 2465 | 1222 | 675 | 412 | 292 |

According to the disclosure, a portable magnetic cleaning apparatus configured to collect metallic debris is disclosed. The apparatus comprises a handle grip, a handle body that is substantially crook-shaped, a quick clean-off sleeve and a magnetic assembly housing a plurality of magnets. The sleeve slips on and off the magnet assembly to clean off metallic debris.

According to the disclosure, the handle and body of the apparatus is aluminum. The handle grip of the apparatus is a vinyl grip and is configured to reduce operator fatigue and accommodate users of different heights.

According to the disclosure, the quick clean-off sleeve is a four-sided plastic sleeve held on and released with push button mechanism. The quick clean-off sleeve of the apparatus further comprises a locking pin cavity, a wear bar, a debris collection area and an extraction handle.

According to the disclosure, the magnet assembly of the apparatus further comprises a spring pin, a steel backplate, an assembly rivet, a magnet tray and rare earth magnets.

According to the disclosure, the handle grip of the apparatus further comprises an arm rest, a hanger, positioning holes, finger positioners and a center weight mass.

According to the disclosure, the magnets of the apparatus are Neodymium 42 rare-earth magnets. The internal rare earth housing consists of an internal plastic device to allow rare earth magnets to be charged as an assembly and then safely handled by the user. The housing holds the rare earth magnets in a proximity to each other that would otherwise push a move or attract to each other after magnetization.

According to the disclosure, the dimensions of sleeve of the apparatus is 14.15″ length, 2.08″ width and 2.08″ height. The dimension of the apparatus are 19.31″ length, 2.08″ width and 46.6″ height or 19.31″ length, 2.08″ width and 50.5″ to 55″ height.

According to the disclosure, a method of assembling a portable magnetic sweeper apparatus comprising a handle grip, a handle body, a quick clean-off sleeve and a magnetic assembly is disclosed. The method consists of the following steps placing back plate in plastic magnet tray, locking the back plate in place with rivets, placing magnet blocks in the magnet tray, magnetizing the magnet assembly, inserting magnet assembly into magnetic sweeper aluminum handle body and installing the rivet through the aluminum handle body into back plate. The quick clean-off sleeve of the method is a four-sided plastic sleeve held on and released with push button mechanism.

According to the disclosure, the handle and body of the method is aluminum and is substantially crook shape. The handle grip of the method has a vinyl grip and is configured to reduce operator fatigue and accommodate users of different heights. The handle grip of the method further comprises an arm rest, a hanger, positioning holes, finger positioners and a center weight mass.

According to the disclosure, magnet block further comprises rare-earth magnets, specifically Neodymium 42 rare-earth magnets. The magnet assembly of the method houses the rare earth magnets in a proximity to each other that would otherwise push a move or attract to each other after magnetization. Furthermore, the magnet assembly consists of an internal plastic device to allow rare earth magnets to be charged as an assembly and then safely handled by the user.

While some embodiments or aspects of the present disclosure may be implemented in fully functioning mechanical, electrical and electrical-mechanical systems, other embodiments may be considered.

The methods disclosed herein comprise one or more steps or actions for achieving the described method. The method steps and/or actions may be interchanged with one another without departing from the scope of the claims. In other words, unless a specific order of steps or actions is I required for proper operation of the method that is being described, the order and/or use of specific steps and/or actions may be modified without departing from the scope of the claims.

The specific embodiments described above have been shown by way of example and understood is that these embodiments may be susceptible to various modifications and alternative forms. Further understood is that the claims are not intended to be limited to the forms disclosed, but to cover all modifications, equivalents, and alternatives falling within the spirit and scope of this disclosure. While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, various changes and modifications in form, material, workpiece, and fabrication material detail may be made, without departing from the spirit and scope of the present disclosure, as set forth in the appended claims, as may be apparent to those of ordinary skill in the art, are also encompassed by the present disclosure.

What is claimed is:

1. A portable magnetic cleaning apparatus configured to collect metallic debris, the apparatus comprising:
a handle grip;
a handle body that is substantially crook-shaped;
a quick clean-off sleeve; and
a magnetic assembly housing a plurality of magnets;
wherein the sleeve slips on and off the magnet assembly to clean off metallic debris.

2. The apparatus of claim 1 wherein the handle and body is aluminum.

3. The apparatus of claim 1 wherein the handle grip has a vinyl grip and is configured to reduce operator fatigue and accommodate users of different heights.

4. The apparatus of claim 1 wherein the quick clean-off sleeve is a four-sided plastic sleeve held on and released with push button mechanism.

5. The apparatus of claim 1 wherein the magnets are Neodymium 42 rare-earth magnets.

6. The apparatus of claim 1 wherein the quick clean-off sleeve further comprises:
a locking pin cavity;
a wear bar;
a debris collection area; and
an extraction handle.

7. The apparatus of claim 1 wherein the magnet assembly further comprises:
a spring pin;
a steel backplate;
an assembly rivet;
a magnet tray; and
rare earth magnets.

8. The apparatus of claim 1 wherein the handle grip further comprises:
an arm rest;
a hanger;
positioning holes;
finger positioners; and
a center weight mass.

9. The apparatus of claim 1 wherein the magnet assembly housing consists of an internal plastic device to allow rare earth magnets to be charged as an assembly and then safely handled by the user.

10. The apparatus of claim 1 wherein the magnet assembly housing holds the rare earth magnets in a proximity to each other that would otherwise push a move or attract to each other after magnetization.

11. The apparatus of claim 1 where the dimensions of the sleeve is 14.15″ length, 2.08″ width and 2.08″ height.

12. The apparatus of claim 1 wherein the dimension of apparatus is 19.31″ length, 2.08″ width and 46.6″ height or 19.31″ length, 2.08″ width and 50.5″ to 55″ height.

13. A method of assembling a portable magnetic sweeper apparatus comprising a handle grip, a handle body, a quick clean-off sleeve and a magnetic assembly, the method consisting of the following steps:
placing back plate in plastic magnet tray;
locking the back plate in place with rivets;
placing magnet blocks in the magnet tray;
magnetizing the magnet assembly;
inserting magnet assembly into magnetic sweeper aluminum handle body;
installing rivet through the aluminum handle body into back plate;

14. The method of claim 13 wherein the handle and body is aluminum and is substantially crook shape.

15. The method of claim 13 wherein handle grip has a vinyl grip and is configured to reduce operator fatigue and accommodate users of different heights.

16. The method of claim 13 wherein the handle grip further comprises:
an arm rest;
a hanger;
positioning holes;
finger positioners; and
a center weight mass.

17. The method of claim 13 wherein the quick clean-off sleeve is a four-sided plastic sleeve held on and released with push button mechanism.

18. The method of claim 13 wherein the magnet block further comprises rare-earth magnets or Neodymium 42 rare-earth magnets.

19. The method of claim 13 wherein the magnet assembly houses the rare earth magnets in a proximity to each other that would otherwise push a move or attract to each other after magnetization.

20. The method of claim 13 wherein the magnet assembly consists of an internal plastic device to allow the rare earth magnets to be charged as an assembly and then safely handled by the user.
